(19) United States
(12) Patent Application Publication
(10) Pub. No.: US 2024/0321240 A1
(43) Pub. Date: Sep. 26, 2024

(54) A REED FOR A MUSICAL INSTRUMENT

(71) Applicant: AUDIO INVENTIONS LIMITED, Farnborough (GB)

(72) Inventors: Brian Smith, Farnborough (GB); Paul Davey, Farnborough (GB)

(21) Appl. No.: 18/576,478

(22) PCT Filed: Jul. 8, 2022
(86) PCT No.: PCT/EP2022/069147

§ 371 Date: Jan. 4, 2024

(30) Foreign Application Priority Data
Jul. 9, 2021 (GB) 2109957.7

(51) Int. Cl. G10D 9/035; G10D 7/066; G10D 7/08; G10D 9/11; G10H 1/055; G10H 3/22

(52) U.S. Cl. CPC G10D 9/035; G10D 9/11; G10H 1/0553; G10H 3/22; G10D 7/066; G10D 7/08; G10H 2220/411; G10H 2230/205

(57) ABSTRACT

A reed (10) for a reed musical instrument has (with reference to FIG. 2) a reed body (129) having a reed tip (114) adapted for engagement by a mouth of a player and a ligature engagement section adapted for engagement by a ligature of the reed musical instrument. A cantilever arm (117) is formed integrally with or affixed to the reed body (129) and extends from the reed body (129). A reflector (20) is supported by the cantilever arm (117) spaced apart from the reed body (129). Motion of the reed tip (114) is transmitted via the cantilever arm (117) to the reflector (20). The cantilever arm (117) is shaped and configured such that the transmitted motion is amplified so that any movement of the reed tip (114) results in a greater movement of the reflector (20). The reed (10) in use is mounted on a mouthpiece (11) and has a distal end (119) which is illuminated by an LED (26), whereby the reflector (20) reflects light back to a light sensor (27), which measures the intensity of the light incident on the sensor (27).

### CROSS-REFERENCE TO RELATED APPLICATIONS

This application is a national stage entry application under 35 U.S.C. 371 of PCT Patent Application No. PCT/EP2022/069147, filed 8 Jul. 2022, which claims priority to GB Patent Application No. 2109957.7 filed 9 Jul. 2021, the entire contents of each of which are incorporated herein by reference.

The present invention relates to a reed for a reed musical instrument and to a musical reed instrument practice kit comprising the reed. The present invention also relates to a reed musical instrument having a mouthpiece and, secured to the mouthpiece by a ligature, the reed of the invention. The present invention additionally provides an assembly of a reed musical instrument and the musical reed instrument practice kit. Further, the present invention provides a method of use of the reed of the invention and a method of use of the musical reed instrument practice kit. Lastly, the present invention provides: a transducer unit; a musical reed instruction practice kit with the reed of the invention and the transducer unit of the invention; and an assembly of the transducer unit of the invention and a reed musical instrument.

In a traditional single-reed woodwind instrument e.g. a clarinet or a saxophone, the reed vibrates and energises the air column within the musical instrument. The tone and pitch of the sound are influenced by how the player's lips interact with the reed, i.e. the player's ‘embouchure’.

By use of electronic apparatus as described in GB2540760A, it is possible for a player to practise playing of a clarinet in near silence whilst hearing synthesised notes through headphones. It is desirable that the tone and pitch of the synthesised notes output by such a device are modulated by the player's embouchure in a realistic way, similar to the modulation of the notes played by the traditional instrument.

A strain transducer attached to a reed is used in the sensor apparatus described in U.S. Pat. No. 5,025,698A. An alternative approach having sensor apparatus with a piezo-electric sensor is described in U.S. Pat. No. 8,586,851 B2. These devices have the disadvantage that the transducer and piezo-electric sensors are connected electrically to the electronic processors of the apparatus, which is challenging since the mouthpiece is a moist environment. The use of electro-magnetic sensors typically require active electronics within the mouthpiece.

JP1243096A describes sensor apparatus that has an optical sensor and an LED. The musical instrument is provided with a weighted pendulum, which can be swung by tilting of the instrument during playing, to break the beam of light travelling from LED to sensor and cause a change in operation.

JPH03219295A and JP03219293A both describe sensor apparatus having sensors attached to reeds to sense movement of the reeds. The sensors attached to the reeds comprise magnets and Hall elements and are thus electro-magnetic sensors disadvantageously located in the moist environment of the mouthpiece. The sensor apparatus described has optical sensors, but these are used to detect ‘tonguing’ and comprise photo sensors and optical fibres leading light to a mouthpiece location that is contacted by the player's tongue.

JP5040122A discloses sensor apparatus having a photocell associated with an LED and a flexible membrane. The flexible membrane flexes with change in pressure applied and therefore acts as a pressure sensor. The sensor apparatus has a sensor attached to the reed of the musical instrument; in common with the prior art described above, the sensor attached to the reed is an electro-magnetic sensor formed of an armature and a five-legged inductance core.

WO2019224996A describes sensor apparatus having a transmission member with a front end that engages a reed and that rotates about a shaft. The rear end of the transmission member has a surface that faces an optical sensor that includes a light emitting unit that irradiates light (infrared rays) toward the rear end surface of the transmission member. The sensor apparatus also includes a light receiving unit that receives light reflected from the rear end surface, to thereby allow sensing of the motion of the transmission member and hence movement of the reed.

The present invention provides: a reed for a reed musical instrument as claimed in claim 1 or claim 3; a musical reed instrument practice kit as claimed in claim 9; a reed musical instrument as claimed in claim 13; an assembly of a reed musical instrument and musical reed instrument practice kit as claimed in claim 14; a method of use of the claim 1 or claim 3 reed as claimed in claim 15; and a method of use of the claim 9 musical reed instrument practice kit as claimed in claim 12. The present invention also provides: a transducer unit as claimed in claim 17; a musical reed instrument practice kit as claimed in claim 19 which has the reed of claim 1 or claim 3 and the transducer unit of claim 17; and an assembly as claimed in claim 20 of the transducer unit of claim 17 and a reed musical instrument.

As mentioned above, it is desirable that the tone and pitch of the synthesised notes output by electronic apparatus used during practice playing of the instrument are modulated by the player's embouchure in a realistic way, similar to the modulation of the notes played by the traditional instrument when playing in the conventional manner. The present invention enables modulation, by measurement of the opening of the reed with respect to the mouthpiece.

The sensor apparatus of the claimed invention measures the closure of a reed using optical means. This enables the measurement to be carried out remote from the reed, within the instrument, and without the need for any electro-magnetic sensor or other electronics within the mouthpiece and the associated moist environment.

With regard to WO2019224996A, the present invention has the several advantages. It allows use of a standard mouthpiece and ligature, so that the player can practice in a realistic manner. The present invention does not require use of a pivoted transmission member, nor the flexible seal associated therewith, both of which will be subject to wear. The present invention provides a reflector associated with the reed that can be removed for cleaning or for cleaning of condensation resulting from a temperature change. The invention can be used with an instrument substantially unmodified, save for use of the reed of the invention in place of a standard reed and the insertion between the mouthpiece and barrel or upper joint of the instrument of a variant of the transducer unit of the type described in WO2017/013455A with reference to FIG. 5a of that patent specification.

The present invention provides for positive illumination of the reflector, so that the illumination current can be gated for power saving and adjusted as part of the initial calibration of the device for use with a particular instrument. The reed of the invention can be easily replaced if worn or damaged. Both the reed and the detector arm of WO2019224996A are vulnerable to damage and the latter forms part of the instrument body and is not easily replaced. In the present invention, the cantilever is integrated into the reed to form a part that is a semi-consumable item that is easily replaced and in the sensor system of the invention the cantilever is attached to the reed rather than the instrument and does not have to pivot on an axle.

Preferred embodiments of a sensor system according to the present invention will now be described with reference to the accompanying drawings, in which:

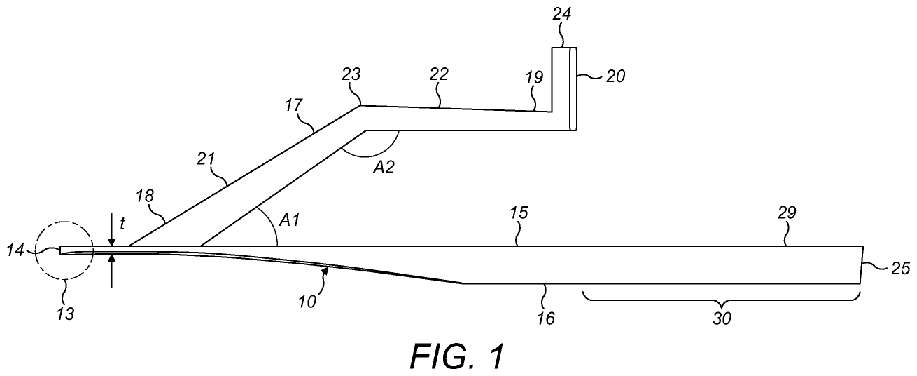

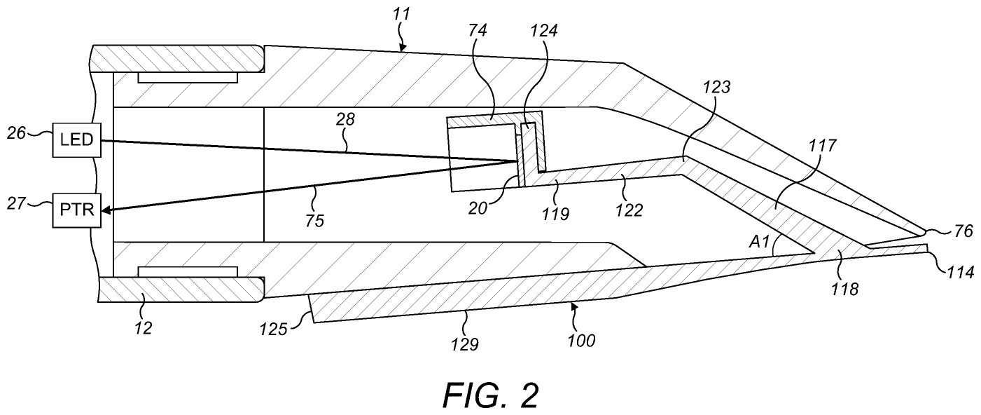

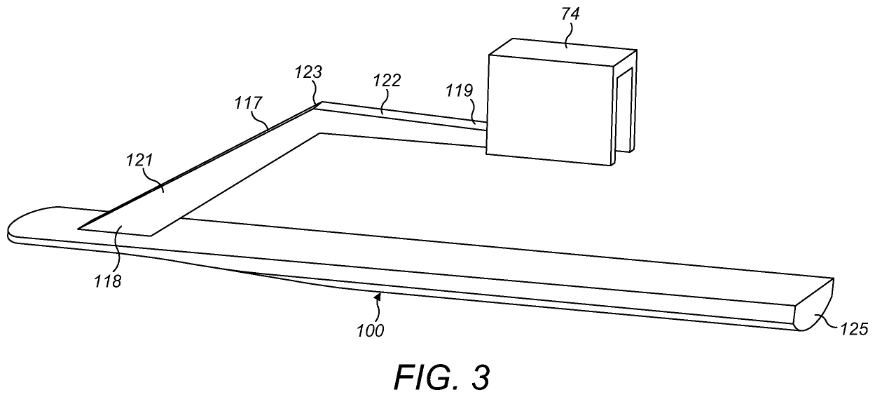

FIG. 1 is a side view of a reed 10 according to a first embodiment of the invention, which could be installed in the mouthpiece 11 of FIG. 2 in place of a reed 100 shown in FIG. 2 (which is the reed 100 of FIG. 3 shown in place in the mouthpiece 11);

FIG. 2 a schematic cross-section through the mouthpiece 11 of a reed instrument showing the reed 100 of FIG. 3 installed and a transducer unit of the present invention attached to the mouthpiece 11;

FIG. 3 is a side view of the reed 100 according to a second embodiment of the invention;

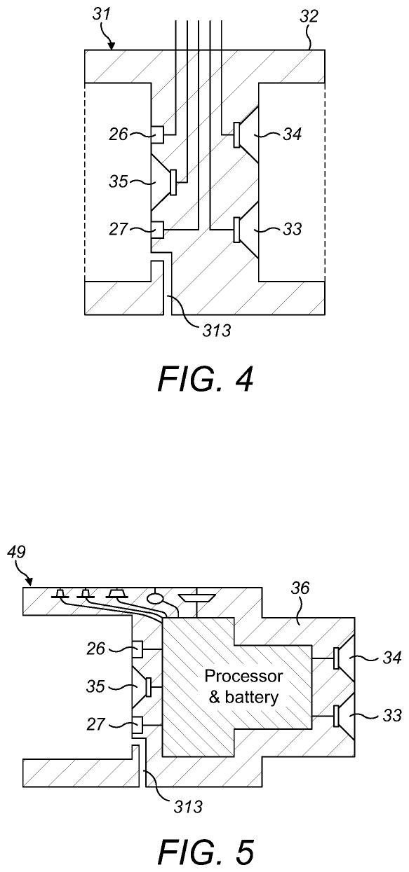

FIG. 4 is a schematic cross-section view of a first embodiment of transducer unit according to the invention;

FIG. 5 is a schematic cross-section view of a second embodiment of transducer unit according to the invention;

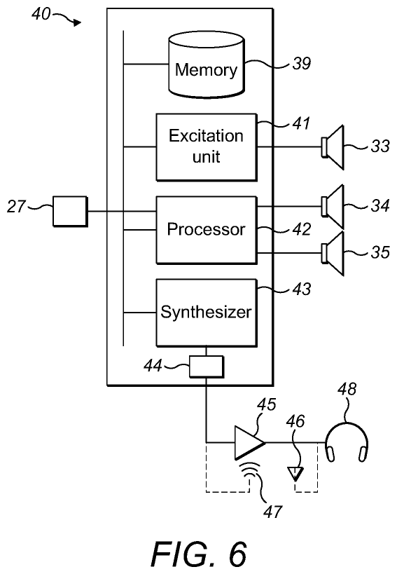

FIG. 6 is a schematic view of an electronic processing unit of the transducer unit of FIG. 4 or FIG. 5;

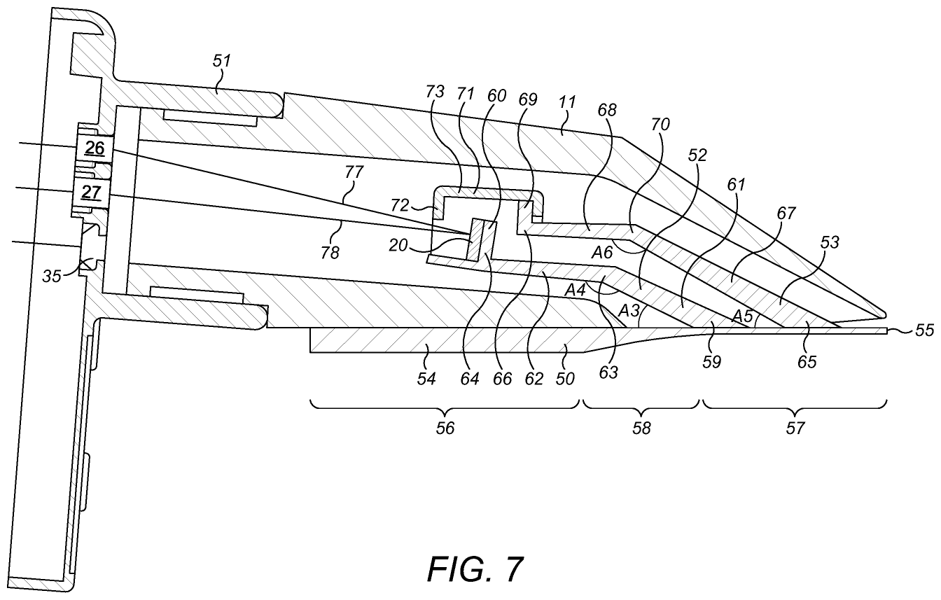

FIG. 7 is a schematic cross-section through an assembly of a reed according a third embodiment of the invention along with a mouthpiece of a reed musical instrument and a transducer unit according to a third embodiment of the invention (only a part of a housing of the transducer unit is shown in the Figure);

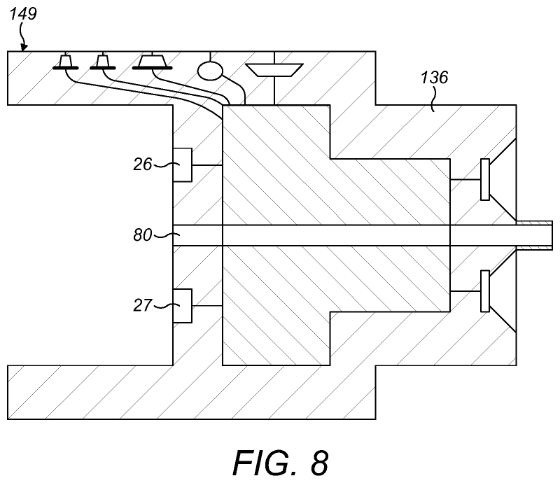

FIG. 8 is a schematic cross-section view of a third embodiment of transducer unit according to the invention; and

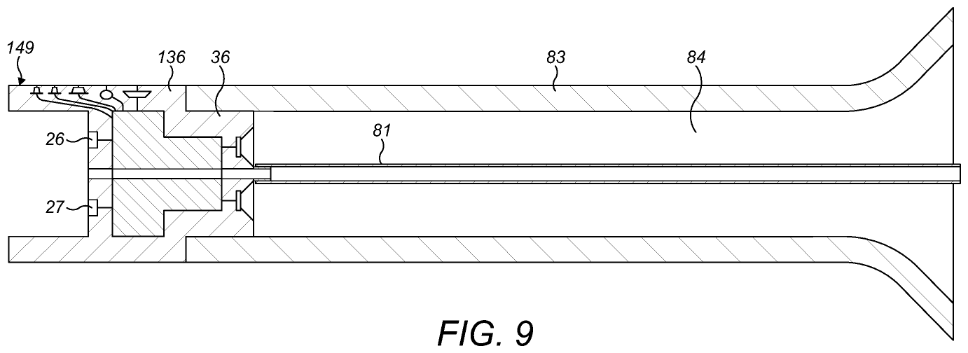

FIG. 9 is a schematic cross-section of the transducer unit of FIG. 8 connected to an assembly of barrel, upper joint, lower joint and bell of a clarinet.

FIG. 1 shows a reed 10 according to an embodiment of the present invention, which can be used to replace the standard cane reed of a reed musical instrument, such as a clarinet. The reed 10 has a reed body 29 that extends from a reed tip 14, which in use is engaged by a mouth of a player of the instrument, to a rear ligature engagement section 30, which in use is engaged by a ligature of the instrument to secure the reed 10 to the instrument. The reed 10 can be used with a standard, unmodified, mouthpiece 11 of the reed instrument and is held in place by the ligature (not shown) that is usually used to hold in place the standard cane reed used to play the instrument. In use of the current invention, the player of the reed instrument will loosen the ligature to remove the standard cane reed used to play the instrument and then replace the standard cane reed with the reed 10, fastening the reed 10 in place on the mouthpiece 11 using the ligature.

References below to “forward” and “rearward” in this specification refer respectively to directions extending toward or away from the reed tip 14.

The reed 10 is typically made of plastic and is injection moulded as a single part or is assembled from a plurality of separately formed parts. The material of the reed 10 and the thickness of the reed 10 are chosen so that the reed 10 will not vibrate when secured to a mouthpiece by a ligature; unlike a standard cane reed, the reed 10 is designed not to vibrate or, at least, to vibrate in an insignificant manner. A biocompatible plastic can be used to injection mould the reed 10. The reed 10 can be provided with a profile in a reed tip area 13 that is slightly thicker than the adjoining section of the reed (this optional thickening is not shown in the figures), in order to dampen any tendency of the reed tip 14 to vibrate when the player blows. The thickest part of the reed 10 is around 3 mm in thickness and a reed tip area 13 has a thickness t of about 0.5 mm (the thickness being the distance between to the two surfaces 15, 16 of the reed 10 respectively facing toward and away from the mouthpiece 11, when the reed 10 is secured to the mouthpiece 11). The thickest part of the reed is 5 to 20%, more preferably 10 to 15%, greater that the thickness t of the reed tip area 13. The thickness will depend on the stiffness of the material of the reed 10 and will be chosen to meet a requirement for the reed 10 not to vibrate/speak in an undesirable fashion. The reed tip is thinner and has a greater propensity to vibrate/speak undesirably, so preferably a minimum thickness of 0.5 mm is desired, even though a standard cane reed will have a much finer tip.

The reed body 29 has the same plan outline (that is, the outline perimeter of the two surfaces 15, 16 of the reed 10 respectively facing toward and away from the mouthpiece 11, when the reed 10 is secured to the mouthpiece 11) as a standard cane reed and, as described above, is held on the mouthpiece 11 with a conventional ligature. The amount of movement of the tip 14 of the reed 10 when the instrument is played is typically small and of the order of a few millimetres, an amount of movement difficult to measure with readily available inexpensive electronic sensors.

The present invention provides the reed 10 with a cantilever arm 17 that advantageously magnifies the movement of the reed tip 14 so that the movement can be more easily measured. The cantilever arm 17 is formed integrally with or is affixed to the reed body 29. The cantilever arm 17 has a proximal end 18 at which the arm 17 joins the reed body 29 and a distal end 19, furthest spaced from the proximal end 18 of the cantilever arm 17. The arm 17 extends from the proximal end 18 to the distal end 19 and a reflector 20 is mounted on the arm 17 at the distal end 19. The cantilever arm 17 is stiff in nature and is shaped and configured to fit within a mouthpiece chamber of the mouthpiece 11.

The cantilever arm 17 has an upper arm portion 21 which extends away from the reed surface 15 and is inclined relative the reed surface such that it extends rearward away from the reed tip 14 at a first included angle A1 (measured between the upper arm portion 21 and the part of the reed surface 15 rearward of the proximal end 18 of the cantilever arm 17). The first included angle A1 is preferably in range 35 to 55 degrees, more preferably 40 to 50 degrees.

The cantilever arm 17 has a lower arm portion 22 joined to the upper arm portion at an elbow 23 at a second included angle A2 (the angle measured between the surfaces of the upper 21 and lower 22 arm portions which face toward to the reed surface 15). The second included angle A2 is preferably in range 125 to 155 degrees, more preferably 130 to 150 degrees. At the distal end 19 of the cantilever arm 17 there is provided a hand portion 24 of the cantilever arm 17 that extends at right angles to the lower arm portion 22. The hand portion 24 holds the reflector 20. The reflector 20 is mounted on the hand portion 24 and is supported by the cantilever arm 17 in a location spaced apart from the reed body 29.

The cantilever arm 17 has a shape and configuration selected such that when installed no part of the cantilever arm 17 touches an inner surface of the mouthpiece 11, since the cantilever arm 17 should be free to move with movement of the reed 10 and any impact of the cantilever arm 17 with the mouthpiece inner surface would alter the motion of the cantilever arm 17. The cantilever arm 17 may touch the mouthpiece inner surface during insertion of the cantilever arm 17 into the mouthpiece 11, but should not touch the mouthpiece inner surface once inserted.

The upper 21 and lower 22 arm portions of the cantilever arm 17 each have a cross section, taken perpendicular to a principal axis of each arm portion, which is rectangular in shape. The cantilever arm 17 tapers in cross-sectional area continuously along each of the upper arm 21 and lower arm 22 portions. The cross-sectional area of the upper arm portion 21 at the proximal end 18 is preferably 10 to 25% larger (more preferably 10 to 15%) than the cross-sectional area of the upper arm portion 21 at the elbow 23. The cross-section area of the lower arm portion 22 at the elbow 23 is preferably 10 to 25% larger (more preferably 10 to 15%) than the cross-sectional area of the lower arm portion 22 at the distal end 19 of the cantilever arm 17. This configuration is chosen since it is important that there is a rigid connection between the proximal end 18 of the cantilever arm 17 and the reed body 29.

The cantilever arm 17 is arranged within the mouthpiece 11 and is shaped and configured so that small movements of the reed tip 14 are magnified by a mechanical advantage into larger movements of the reflector 20 at the distal end 19 of the cantilever arm 17. The motion of the reed tip 14 is transmitted via the cantilever arm 17 to the reflector 20 and the cantilever arm is shaped and configured so that the transmitted motion is amplified such that any movement of the reed tip 14 results in a greater movement of the reflector 20.

The reflector 20 is a light reflecting surface or optical mirror forming part of or attached to the hand portion 24 of the free distal end 19 of the cantilever arm 17 and located in the mouthpiece 11 such that light shone toward a tip 76 of mouthpiece 11 is reflected back down the mouthpiece 11, away from the mouthpiece tip 76. References to ‘light’ in this specification are not limited to visible light and should be taken to include infrared and ultra-violet light.

Optionally a hood can be fitted over the reflector 20 to mitigate the effect of any moisture droplets falling from the inner surface of the mouthpiece 11. In FIGS. 2 and 3, a second embodiment of reed 100 is shown with a hood 74 that is either clipped to a hand portion 124 of a cantilever arm 117 or is integrally formed with the cantilever arm 117, e.g. by moulding or 3D printing. The reed 100 of FIG. 3 is otherwise identical to the reed 10 of FIG. 1 and in FIGS. 2 and 3 the reference numerals used for parts of the reed 100 correspond to the reference numerals for identical parts of the reed 10 of FIG. 1, except that an additional numeral 1 has been added at the beginning of each reference number, e.g. the cantilever arm 17 of FIG. 1 is a cantilever arm 117 in FIG. 3. If the hood 74 is a clip-on part then it can be easily removed to allow cleaning of the hood 74 and the reflector 20.

In FIG. 2 there is shown a light source in the form of an LED (Light Emitting Diode) 26 that emits an emitted beam of light 28 directed toward the tip 76 of the mouthpiece 11 whereby the distal end of the cantilever arm 117 is illuminated by the light emitted by the LED 26. The beam of light is reflected back by the reflector 20 to form a reflected beam of light 75 that is directed toward a light sensor 27 (typically a phototransistor (“PTR”)), which measures the intensity of the light incident on the sensor 27.

The cantilever arm 117 is arranged so that an angle subtended by the plane of the reflecting surface of the reflector 20 relative to a beam of light 28 incident on the reflector 20 changes as the reed 100 bends. This changes the optical path of the reflected beam of light 75 shown in FIG. 2. Therefore, the amount of light incident on the light sensor 27 varies according to the angle of the reflector surface relative to the light incident on the reflector 20.

The intensity of the light incident on the light sensor 27 will reduce constantly as the reed 100 is closed from an open position by a player of the instrument and will increase constantly as the reed 100 opens from a closed position. Therefore, the position of the reed 100 can be determined from a light sensor output signal. It is important to ensure an alignment of the reflector surface with the light incident on the surface such that the reflected light incident on the light sensor 27 constantly decreases with reed closing and constantly increases with reed opening (or vice versa), since it would be possible to position the reflector 20 such that the intensity of the reflected light incident on the light sensor 27 first increases then decreases with e.g. movement of the reed from an open to a closed position; this would make any output signal of the light sensor 27 ambiguous as to the reed position. The output of light sensor 27 should be monotonic as the reed 100 moves in one sense of movement, i.e. monotonic as the reed 100 moves from a closed to an open position and monotonic as the reed 100 moves from an open to a closed position.

The assembly of the reed 10 or reed 100 and the reflector 20 is totally passive, i.e. does not require a powered sensor or other electronics built into the reed 10 or reed 100 or into the mouthpiece 11. The assembly uses movement of a reflective surface of the reflector 20 and, preferably, also a change in the angle that the reflector 20 subtends relative to the principal axis of the mouthpiece 11 to remotely convey the bend of the tip 14 of the reed 10 or the tip 114 of reed 100. Neither the reed 10 nor the reed 100 need any electrical connection (the same is true for the additional reed embodiment of FIG. 7).

The reed 10 or reed 100 can be removed from the musical instrument and cleaned conventionally. The reflective surface of the reflector 20 will preferably be provided with a coating resistant to condensation and/or will be formed from a condensation resistant material.

As described above, a simple LED 26 is used to direct light at the reflector 20. The reflected light is collected by the light sensor 27 (e.g. phototransistor) as shown in FIG. 2. The light sensor 27 provides a measurement signal that can be amplified as necessary for measurement by a microprocessor. The LED 26 and the phototransistor 27 are incorporated as part of a transducer unit of the type described with reference to FIG. 5a of WO2017/013455A, as described below. A tunnel can be fitted or moulded in the housing of the transducer unit, extending around the LED 26 and/or phototransistor 27 in order to reduce or eliminate undesirable reflections, e.g. from a moist inner surface of the mouthpiece 11.

The LED 26 preferably emits light of a wavelength advantageously chosen to be resilient to transmission through a moist atmosphere, e.g. using a wavelength in the infrared spectrum, e.g. 940 nm.

The transducer unit (e.g. the units 31 and 49 of FIGS. 4 and 5) has an electronic processing unit 40 (see FIG. 6), including a microprocessor 42 and a memory 39, that is programmed with a calibration routine. When the calibration routine is activated then the intensity of reflected light beam 75 sensed by the phototransistor 27 is measured while the player manually positions the reed 10 or 100 in a minimum of two pre-defined positions, e.g. a fully open position and a fully closed position. This is advantageously carried out with the player holding the instrument in the normal playing position, i.e. with the mouthpiece 11 in the player's mouth. Once calibrated, then the microprocessor 42 compares the reflected light signal sensed by the phototransistor 27 with the measurements taken during calibration, in order to determine accurately the position of the reed tip 14 or 114 of reed 10 or 100 whilst the player is playing the instrument. A combination of the sensed reed tip position and a sensed blowing pressure (measured by a pressure sensor 35, shown in FIGS. 4, 5 and 6) is used to refine the synthesizing of an output signal of the transducer unit 31, 49, to thereby increase the realism of the synthesised sound output by a speaker or headphones 48 (see FIG. 6), through note-transients, steady state harmonic content, pitch frequency and volume.

Transducer units of the type described with reference to FIGS. 5a and 5b of WO2017/013455A, but adapted for use with the current invention are shown in FIGS. 4 and 5 of this specification. FIG. 4 shows a transducer unit 31 for replacing a barrel of a musical reed instrument and for connection between the mouthpiece 11 and an upper joint of a musical reed instrument. In FIG. 4, the transducer unit 31 has a housing 32 formed as a barrel part. The housing 32 comprises a barrier to isolate the mouthpiece 11 from the air chamber of the instrument. The transducer unit 31 has an air chamber speaker 33 and an air chamber microphone 34 that are arranged to face into the air chamber of the musical instrument (e.g. the air chamber formed at least in part by the upper and lower joints and bell of a clarinet). The transducer unit 31 has the pressure sensor 35 that is arranged to sense air pressure in the mouthpiece chamber of the mouthpiece 11.

FIG. 5 shows a transducer unit 49 with a transducer unit housing 36 that houses a battery for powering the transducer unit 49 and also electronic components of the transducer unit 49, including the excitation unit 41, the microprocessor 42, the output means 44 and the memory 39 (see FIG. 6). There may additionally be provided in or on the housing: a charging and/or communication connection point (such as a micro-USE connector), which may be part of, or additional to, the output means 44; a socket for headphones; controls for activating the transducer unit 49 or its various features; and/or a status display (such as one or more LEDs).

The transducer unit housing 32 shown in FIG. 4 has two female connectors and would be used in place of a barrel with the female connectors used to connect the housing to male connectors of an upper joint and a mouthpiece. The transducer unit housing 36 of FIG. 5 has one male and one female connector and the transducer unit 49 will be connected between a mouthpiece 11 and a barrel of a reed musical instrument. However, the housings may be configured to have any combination of male and/or female connectors necessary to fit with a desired reed musical instrument, either between the mouthpiece and an adjacent part of the reed musical instrument or replacing the part of the reed musical instrument adjacent to the mouthpiece.

The transducer unit housings 32 and 36 may have formed therein a passage 313 from the mouthpiece chamber to a bleed hole 37. This can give players the impression that they are playing the instrument normally, but without allowing them to excite the air in the barrel air chamber. The pressure sensor 35 could be mounted in the passage 313. The bleed hole 37 can also allow condensate to escape the mouthpiece 11.

The transducer units 31 and 49 are adapted for use with the current invention, by the mounting of the light source 26 and light sensor 27 in each unit, facing the mouthpiece chamber when the transducer units 31 and 49 are coupled between a mouthpiece 11 and a further part of a reed musical instrument, as described above.

FIG. 6 shows a schematic representation of an electronic processing unit 40 for synthesizing the sound of a musical reed instrument. The electronic processing unit 40 has an excitation unit 41 that can produce an excitation signal for driving the air chamber speaker 33. The electronic processor has a microprocessor 42 which is connected to the air chamber microphone 34 to receive a measurement signal therefrom and which is adapted to detect from the measurement signal a musical note played by the instrument. The electronic processing unit 40 has a synthesizer 43 for generating a synthesized electronic signal embodying a musical note corresponding to the detected musical note. The electronic processor has an output means 44 adapted to output the synthesized electronic signal, e.g. to an amplifier 45 and then to headphones 48. Alternatively, the output could be a Bluetooth™ signal transmitted by a transmitter 47 and received by a Bluetooth™ receiver 46 connected the headphones 48. A speaker could replace the headphones 48.

The light sensor 27 generates a light measurement signal indicative of the intensity of the received light and the microprocessor 42 and/or the synthesizer 43 is/are connected to the light sensor 27 to receive the light measurement signal therefrom and to use the light measurement signal as an input signal in the generation of the synthesized electronic signal. The pressure sensor 35 senses pressure of air in the mouthpiece chamber and generates a mouthpiece air pressure signal indicative of the sensed mouthpiece air pressure. The microprocessor 42 uses the signals it receives to determine which musical note is played. The microprocessor 42 receives an input signal from the light sensor 27 and an input signal from the pressure sensor 35. The microprocessor 42 also receives the output from the air chamber microphone 34. The microprocessor 42 will use one of a variety of well-known techniques for analysing a resonant cavity to measure or estimate its resonance and thereby detect a played musical note from the output of the air chamber microphone 34. These include, but are not limited to, application of maximum length sequences, time-domain reflectometry, swept sine analysis, chirp analysis, and mixed sine analysis. These are fully described in WO2017/013455A. The detected musical note is relayed to the synthesizer 43 which then synthesizes an output signal to be output audibly by the headphones 48 (or one or more speakers). The synthesizer 43 can also receive the mouthpiece air pressure signal and/or the signal output by the light sensor 27 as (a) further input signal(s) used to modulate the synthesized electronic signal output to the headphones 48 (or the speaker(s)).

FIG. 7 shows a third embodiment of reed 50 mounted to the mouthpiece 11, which in turn is inserted in a socket of a housing 51 of a third embodiment of transducer unit (only a part of the housing 51 is shown the FIG. 7). The transducer unit will have the components of the transducer units 31 and 49, the only difference being a housing 51 for the transducer unit that is of a different shape and configuration, and therefore the FIG. 7 transducer unit is not described further.

The reed 50 differs from the reeds of the earlier embodiment in that it is provided with not just one, but a pair of cantilever arms 52 and 53. As with the earlier embodiments, the reed 50 has a reed body 54 having a reed tip 55 that can be engaged by the mouth of player of the reed musical instrument. The reed body 54 also has a rear ligature engagement section 56 which has a surface facing away from the mouthpiece which is engaged by a ligature (not shown in the figure) to secure the reed 50 to the mouthpiece. The rear ligature engagement section 56 is of a greater thickness than a reed tip section 57 of the reed 50 adjacent the reed tip 55. A reed section 58 of tapering thickness joins the reed tip section 57 and the rear ligature engagement section 55.

The cantilever arm 52 is formed integrally with or is affixed to the reed body 54. The cantilever arm 52 has a proximal end 59 at which the arm 52 is joined to the reed body 54 and a distal end 60, furthest spaced from the proximal end 59 of the cantilever arm 52. The cantilever arm 52 extends from the proximal end 59 to the distal end 60 to a reflector 20 mounted at the distal end 60. The cantilever arm 52 is stiff in nature and is shaped and configured to fit within a mouthpiece chamber of the mouthpiece 11.

The cantilever arm 52 has an upper arm portion 61 which extends away from the reed body 54 and is inclined relative the reed body 54 such that it extends rearward away from the reed tip 55 at a first included angle A3 (measured between the upper arm portion 21 and a surface of a part of the reed body 54 rearward of the proximal end 59 of the cantilever arm 52). The first included angle A3 is preferably in range 35 to 55 degrees, more preferably 40 to 50 degrees.

The cantilever arm 52 has a lower arm portion 62 joined to the upper arm portion at an elbow 63 at a second included angle A4 (the angle measured between the surfaces of the upper 21 and lower 22 arm portions which face toward to the reed body 54). The second included angle A4 is preferably in range 125 to 155 degrees, more preferably 130 to 150 degrees.

At the distal end 60 of the cantilever arm 52 there is provided a hand portion 64 of the cantilever arm 52 that has finger section extending at right angles to the lower arm portion 62 and a thumb section extending rearwardly as a continuation of the lower arm portion 62. The hand portion 64 holds the reflector 20. The reflector 20 is mounted on the hand portion 64 and supported by the cantilever arm 52 in a location spaced apart from the reed body 54.

The cantilever arm 52 has a shape and configuration selected such that when installed no part of the cantilever arm 52 touches the inner surface of the mouthpiece 11, since the cantilever arm 52 should be free to move with movement of the reed 50 and any impact of the cantilever arm 52 with the mouthpiece inner surface would alter the motion of the cantilever arm 52. The cantilever arm 52 may touch the mouthpiece inner surface during insertion of the cantilever arm 52 into the mouthpiece 11, but should not touch the mouthpiece inner surface once inserted.

The upper 61 and lower 62 arm portions of the cantilever arm 52 each have a cross section, taken perpendicular to the principal axis of each arm portion, which is rectangular in shape. The cantilever arm 52 tapers in cross-sectional area continuously along each of the upper arm 61 and lower arm 62 portions. The cross-sectional area of the upper arm portion 61 at the proximal end 59 is preferably 10 to 25% larger (more preferably 10 to 15%) than the cross-sectional area of the upper arm portion 61 at the elbow 63. The cross-section area of the lower arm portion 62 at the elbow 63 is preferably 10 to 25% larger (more preferably 10 to 15%) than the cross-sectional area of the lower arm portion 62 at the distal end 60 of the cantilever arm 52. This configuration is chosen since it is important that there is a rigid connection between the proximal end 59 of the cantilever arm 52 and the reed body 54.

The cantilever arm 53 is formed integrally with or is affixed to the reed body 54. The cantilever arm 53 has a proximal end 65 at which the arm 53 is joined to the reed body 54 and a distal end 66, furthest spaced from the proximal end 65 of the cantilever arm 53. The arm 53 extends from the proximal end 59 to the distal end 66 to a hood 71 mounted at the distal end 66. The cantilever arm 53 is stiff in nature and is shaped and configured to fit within the mouthpiece chamber of the mouthpiece 11.

The cantilever arm 53 has an upper arm portion 67 which extends away from the reed body 54 and is inclined relative the reed body 54 such that it extends rearward away from the reed tip 55 at a first included angle A5 (measured between the upper arm portion 67 and the part of the reed body 54 rearward of the proximal end 65 of the cantilever arm 53). The first included angle A5 is preferably in range 35 to 55 degrees, more preferably 40 to 50 degrees.

The cantilever arm 53 has a lower arm portion 68 joined to the upper arm portion 67 at an elbow 70 at a second included angle A6 (the angle measured between the surfaces of the upper 67 and lower 68 arm portions which face toward to the reed body 54). The second included angle A6 is preferably in range 125 to 155 degrees, more preferably 130 to 150 degrees.

At the distal end 66 of the cantilever arm 53 there is provided a hand portion 69 of the cantilever arm 53 that extends at right angles to the lower arm portion 62. The hand portion 69 holds a hood 71 which extends rearward of the hand portion and spans over the hand portion 64 of the first cantilever arm 52 and the reflector 20. The hood 71 has a rearward located reflector-obscuring element 72 which can, as described below, be interposed between the light source 26 and the reflector 20 to reduce in amount incident light reaching the reflector 20 from the light source and the amount of reflected light reflected back from the reflector 20 to the light sensor 27. The hood 71 is mounted on the hand portion 69 and supported by the cantilever arm 53 in a location spaced apart from the reed body 54.

The cantilever arm 53 has a shape and configuration selected such that when installed no part of the cantilever arm 53 touches the inner surface of the mouthpiece 11, since the cantilever arm 53 should be free to move with movement of the reed 50 and any impact of the cantilever arm 53 with the mouthpiece inner surface would alter the motion of the cantilever arm 53. The cantilever arm 53 may touch the mouthpiece inner surface during insertion of the cantilever arm 53 into the mouthpiece 11, but should not touch the mouthpiece inner surface once inserted.

The upper 67 and lower 68 arm portions of the cantilever arm 53 each have a cross section, taken perpendicular to the principal axis of each arm portion, which is rectangular in shape. The cantilever arm 53 tapers in cross-sectional area continuously along each of the upper arm portion 67 and lower arm 68 portions. The cross-sectional area of the upper arm portion 67 at the proximal end 65 is preferably 10 to 25% larger (more preferably 10 to 15%) than the cross-sectional area of the upper arm portion 67 at the elbow 70. The cross-section area of the lower arm portion 68 at the elbow 70 is preferably 10 to 25% larger (more preferably 10 to 15%) than the cross-sectional area of the lower arm portion 68 at the distal end 66 of the cantilever arm 53. This configuration is chosen since it is important that there is a rigid connection between the proximal end 65 of the cantilever arm 53 and the reed body 54.

The cantilever arm 53 is arranged within the mouthpiece 11 and is shaped and configured so that small movements of the reed tip 55 are magnified by a mechanical advantage into larger movements of the hood 71 at the distal end 66 of the cantilever arm 53. The motion of the reed tip 55 is transmitted via the cantilever arm 53 to the hood 71 and the cantilever arm 53 is shaped and configured so that the transmitted motion is amplified such that any movement of the reed tip 55 results in a greater movement of the hood 71.

The cantilever arms 52, 53 are connected only to the reed body 54 and are not otherwise connected to each other. Both cantilever arms 52, 53 will move with movement of the reed tip 55, but since the cantilever arm 53 is joined to the reed body 54 nearer the reed tip 55 then for any given movement of the reed tip 55, the cantilever arm 53 will move more than the cantilever arm 52. Furthermore, the cantilever arm 53 joins the reed body 54 at a portion of increasing thickness of the reed body 54, which also serves to decrease the movement of the cantilever arm 52 with respect to the cantilever arm 53, which joins the reed body 54 at a section of minimum thickness. Lips of a player of the reed musical instrument move the reed 50 about 10 mm at the reed tip 55.

The hood 71 is U-shaped in a cross-section taken transverse to a principal axis of the mouthpiece 11 and transverse to the lengthwise axis of the second cantilever arm 53. It has a roof section 73 and two sidewalls extending from the roof section 73 to sandwich between them the hand portion 64 of the cantilever arm 52. The sidewalls prevent light reflected from sidewalls of the mouthpiece 11 reaching the reflector 20.

The light source 26 previously described (typically an LED) is mounted in the housing 51 to direct a beam of light 77 toward to the reflector 20. A beam of reflected light 78, reflected by the reflector 20, is incident on light sensor 27 (typically a PTR) also mounted in the housing 51, spaced apart from the light source 26. The light sensor 27 outputs a signal indicative of the intensity of the light incident on the light sensor 27, the output signal then being used by the transducer unit in the manner described above. The amount of light reflected is dependent on how much of the reflector 20 is obscured by the reflector-obscuring element 72 of the hood 71. The reflector-obscuring element 72 both prevents light from the light source reaching the reflector 20 and also prevents reflected light reaching the light sensor 27.

The amount of light incident on the light sensor 27 also varies according to the angle of the reflector surface relative to the light incident on the reflector 20. The intensity of the reflected light incident on the light sensor 27 will reduce constantly as the reed 50 is closed from an open position by a player of the instrument and will increase constantly as the reed opens from a closed position. Therefore, the position of the reed 50 can be determined from the light sensor output signal. It is important to ensure an alignment of the reflector surface with the incident light that achieves a constant decrease with reed closing and a constant increase with reed opening (or vice versa), since would be possible to position the reflector such that the intensity of the reflected light incident on the light sensor 27 first increases then decreases with movement of the reed from an open to a closed position; this would make any output signal of the light sensor 27 ambiguous as to the reed position. The output of light sensor 27 should be monotonic as the reed 50 moves in one sense of movement, i.e. monotonic as the reed 50 moves from a closed to an open position and monotonic as the reed 50 moves from an open to a closed position.

When the reed tip 55 is engaged by the mouth of a player of the reed musical instrument, then movement of the reed tip results in differential movement between the cantilever arms 52 and 53, with the result that the reflector-obscuring element 72 moves to obscure the reflector 20. The degree of obscuration is dependent on the amount of motion of the reed tip and thus the amount of motion of the cantilever arm 53 relative to the cantilever arm 52. As described above, motion of the cantilever arm 52 will also change the direction of the beam deflected by the reflector 20 and this will also affect the intensity of light incident on the light sensor.

The pressure sensor 35 described above in relation to earlier figures can also be seen in FIG. 7.

FIG. 8 is an illustration of a variant 149 of the transducer unit 49. Most components are identical and so reference numerals have been used in FIG. 8 which correspond with reference numerals of FIG. 5, save that the numeral 1 prefixes them, e.g. a transducer unit housing 136 in FIG. 8 corresponds to the housing 36 of FIG. 5. The housing 136 houses a battery for powering the transducer unit 149 and also electronic components of the transducer unit 149, including an excitation unit 41, a microprocessor 42, an output means 44 and a memory 39 (see FIG. 6). There may additionally be provided in or on the housing: a charging and/or communication connection point (such as a micro-USB connector), which may be part of, or additional to, the output means 44; a socket for headphones; controls for activating the transducer unit or its various features; and/or a status display (such as one or more LEDs). The transducer unit will be provided with a pressure sensor 35 for sensing pressure in the mouthpiece chamber, but this is not shown in the cross-section of FIG. 8, since it lies outside the plane of the cross-section.

The transducer unit 149 will in use be connected e.g. between a mouthpiece and a barrel of a clarinet. The mouthpiece will have a mouthpiece chamber and the barrel will provide, along with an upper joint, a lower joint and a bell (shown in FIG. 9 for simplicity as a single part 83), an air chamber 84 for the instrument. The transducer unit 149 has, in comparison with the unit 49, a breath passage 80 therethrough for connecting the mouthpiece chamber to a flexible breath tube 81 (see FIG. 9) via a male coupling 82. This is provided instead of the passage 313 shown in FIG. 4. The flexible breath tube 81 conveys breath of a player of the instrument from the breath passage 80 in the housing through the air chamber 84 to be vented to atmosphere outside of the air chamber 84. As can be seen in FIG. 9, and the flexible breath tube 81 extends from the transducer unit housing 136 inside the air chamber 84 along an entire length of the air chamber 84 to protrude out of the bell to thereby deliver breath of the player to atmosphere while keeping the breath in the tube 81 separate from air in the air chamber 84. It is important to maintain this separation to ensure reliable detection of the played musical note by the transducer unit 149.

In the arrangement of FIGS. 8 and 9 condensate from the player's breath will drain out of the open end of the breath tube 81 (rather than at the end of the passage 313 in FIG. 4). Instrument players are used to condensate falling from the bell end of an instrument and will not be troubled by this. However, condensate leaving the passage 313 may run down an exterior surface of the instrument, which may be uncomfortable for the player of the instrument.

The breath tube 81 is described above as flexible since this aids insertion of the breath tube through the air chamber of the instrument and/or removal from the air chamber and/or packing of the breath tube 81 in a case for transport. However, the breath tube would function equally well if it is rigid.

1. A reed for a reed musical instrument comprising:
a reed body having a reed tip adapted for engagement by a mouth of a player and a ligature engagement section adapted for engagement by a ligature of the reed musical instrument;
a cantilever arm formed integrally with or affixed to the reed body which extends from the reed body; and
a reflector supported by the cantilever arm spaced apart from the reed body; wherein:
motion of the reed tip is transmitted via the cantilever arm to the reflector; and
the cantilever arm is shaped and configured such that the transmitted motion is amplified so that any movement of the reed tip results in a greater movement of the reflector.

2. A reed as claimed in claim 1, comprising additionally a hood secured to or formed integrally with the cantilever arm, wherein the hood surrounds the reflector at least in part to divert drops of moisture from landing on the reflector.

3. A reed for a reed musical instrument comprising:
a reed body having a reed tip adapted for engagement by a mouth of a player and a ligature engagement section adapted for engagement by a ligature of the reed musical instrument;
a first cantilever arm formed integrally with or affixed to the reed body, which extends from the reed body; and
a reflector supported by the first cantilever arm spaced apart from the reed body;
a second cantilever arm formed integrally with or affixed to the reed body, which extends from the reed body;
a reflector-obscuring element for obscuring the reflector, which is supported by the second cantilever arm, spaced apart from the reed body;
wherein:
motion of the reed tip is transmitted via the second cantilever arm to the obscuring element; and
the second cantilever arm is shaped and configured such that the transmitted motion is amplified so that any movement of the reed tip results in a greater movement of the reflector-obscuring element.

4. A reed as claimed in claim 2 wherein the second cantilever arm joins the reed body at point nearer the reed tip than a point at which the first cantilever joins the reed body, whereby motion of the reed tip occasions greater movement of the second cantilever arm than of the first cantilever arm and thereby relative motion of the second cantilever arm toward or away from the first cantilever arm.

5. A reed as claimed in claim 3, comprising a hood secured to or formed integrally with the second cantilever arm, wherein the hood surrounds the reflector at least in part to divert drops of moisture from landing on the reflector and wherein the reflector-obscuring element is attached to or forms part of the hood.

6. A reed as claimed in claim 1 wherein the cantilever arm comprises:
an upper arm section;
an elbow;
a lower arm section; and
a hand section for supporting the reflector or the obscuring element; wherein
the upper arm section extends from the reed body to the elbow;
the lower arm section extends from the elbow to the hand section;
a first included angle between the upper arm section and the reed body is in the range 35 to 55 degrees; and
a second included angle at the elbow between the upper arm section and the lower are section is in the range 125 to 155 degrees.

7. A reed as claimed in claim 6 wherein:
the upper arm section of the cantilever arm tapers from the reed body to the elbow whereby the upper arm section has a cross-section area, taken perpendicular to a principal axis of the upper arm section, which is greater at a reed body end of the upper arm section than at an elbow end of the upper arm section.

8. A reed as claimed in claim 6 wherein:
the lower arm section of the cantilever arm tapers from the elbow to the hand portion whereby the lower arm section has a cross-section area, taken perpendicular to a principal axis of the lower arm section, which is greater at an elbow end of the lower arm section than at a hand portion end of the lower arm section.

9. A musical reed instrument practice kit comprising a reed as claimed in claim 1 and a transducer unit, the transducer unit comprising:
a transducer unit housing adapted to be connected to a musical reed instrument between a mouthpiece and a section of the instrument in which a resonant air chamber is at least partly formed;
an air chamber speaker adapted to deliver sound to the air chamber of the instrument;
an air chamber microphone adapted to receive sound in the air chamber of the instrument;
an electronic processing unit having: an excitation unit which can produce an excitation signal for driving the air chamber speaker; a processor which is connected to the air chamber microphone to receive a measurement signal therefrom and which is adapted to detect from the measurement signal a musical note played by the instrument; a synthesizer for generating a synthesized electronic signal embodying a musical note corresponding to the detected musical note; and an output means adapted to output the synthesized electronic signal;
a light source adapted to emit light into a mouthpiece chamber of the mouthpiece; and
a light sensor adapted to receive light reflected from the reflector supported by the cantilever arm and to generate a light measurement signal indicative of the intensity of the received light; wherein:
the processor and/or the synthesizer unit is/are connected to the light sensor to receive the light measurement signal therefrom and to use the light measurement signal as an input signal in the generation of the synthesized electronic signal.

10. A musical reed instrument practice kit as claimed in claim 9 wherein the transducer unit comprises additionally a pressure sensor adapted to sense pressure of air in the mouthpiece chamber and to generate a mouthpiece air pressure signal indicative of the sensed mouthpiece air pressure and wherein the processor and/or the synthesizer unit is/are connected to the pressure sensor to receive the mouthpiece air pressure measurement signal therefrom and to use the mouthpiece air pressure signal as an input signal in the generation of the synthesized electronic signal.

11. A musical reed instrument practice kit as claimed in claim 9 wherein the light source emits light in the infrared spectrum.

12. A musical reed instrument practice kit as claimed in claim 9 comprising a breath tube and wherein the transducer unit housing is provided with a breath passage therethrough adapted to connect the mouthpiece chamber with the breath tube, the breath tube being adapted to convey breath of a player of the instrument from the breath passage in the housing through the air chamber to be vented to atmosphere outside of the air chamber.

13. A reed musical instrument having a mouthpiece and, secured to the mouthpiece by a ligature, a reed as claimed in claim 1, wherein:
the cantilever arm extends through an aperture in the mouthpiece;
the reflector is located within a mouthpiece cavity in the mouthpiece, facing away from a tip end from the mouthpiece cavity; and
the cantilever arm is connected to the mouthpiece only via the reed body.

14. An assembly of a reed musical instrument and musical reed instrument practice kit as claimed in claim 9 wherein:
the transducer unit housing of the musical reed instrument practice kit is secured between the mouthpiece and the section of the musical instrument in which the air chamber is at least partly formed, with the air chamber speaker and the air chamber microphone facing into the air chamber and with the light source and the light sensor facing into the mouthpiece chamber of the mouthpiece;
the reed of the musical reed instrument practice kit secured to the mouthpiece by a ligature with the cantilever arm of the reed extending through an aperture in the mouthpiece into the mouthpiece chamber;
the reflector is located within the mouthpiece chamber facing away from a tip end from the mouthpiece chamber and facing toward the light source and the light sensor; and
the cantilever arm is connected to the mouthpiece only via the reed body.

15. A method of use of the reed of claim 1 comprising:
replacing a standard reed of a reed musical instrument reed with the reed claimed in claim 1, securing said reed to a mouthpiece of the reed musical instrument with a ligature of the reed musical instrument;
inserting the cantilever arm of said reed into a mouthpiece chamber through an aperture in the mouthpiece; and
locating the reflector within the mouthpiece chamber with the reflector facing away from a tip end from the mouthpiece chamber.

16. A method of use of the musical reed instrument practice kit of claim 9 comprising:
replacing a standard reed of a reed musical instrument reed with the reed claimed in claim 9, securing said reed to a mouthpiece of the reed musical instrument with a ligature of the reed musical instrument;
inserting the cantilever arm of said reed through an aperture in the mouthpiece;
locating the reflector within a mouthpiece chamber in the mouthpiece, with the reflector facing away from a tip end from the mouthpiece chamber; and
securing the housing of the transducer unit between the mouthpiece and a section of the reed musical instrument in which a resonant air chamber is at least partly formed, with the air chamber speaker and the air chamber microphone operative in the air chamber and with the light source and the light sensor operative in the mouthpiece chamber.

17. A transducer unit for use with a musical reed instrument practice, the transducer unit comprising:
a transducer unit housing adapted to be connected to a musical reed instrument between a mouthpiece and a section of the instrument in which a resonant air chamber is at least partly formed;
an air chamber speaker adapted to deliver sound to the resonant air chamber of the instrument;
an air chamber microphone adapted to receive sound in the resonant air chamber of the instrument;
an electronic processing unit having: an excitation unit which can produce an excitation signal for driving the air chamber speaker; a processor which is connected to the air chamber microphone to receive a measurement signal therefrom and which is adapted to detect from the measurement signal a musical note played by the instrument; a synthesizer for generating a synthesized electronic signal embodying a musical note corresponding to the detected musical note;
an output means adapted to output the synthesized electronic signal; and
a breath tube; wherein:
the transducer unit housing is provided with a breath passage therethrough adapted to connect the mouthpiece chamber with the breath tube; and
the breath tube is adapted to convey breath of a player of the instrument from the breath passage in the housing through the resonant air chamber to be vented to atmosphere outside of the air chamber.

18. A transducer unit as claimed in claim 17 comprising additionally:
a light source adapted to emit light into a mouthpiece chamber of the mouthpiece; and
a light sensor adapted to receive light reflected from a reflector located in the mouthpiece chamber and which generates a light measurement signal indicative of the intensity of the received light; wherein:
the processor and/or the synthesizer unit is/are connected to the light sensor to receive the light measurement signal therefrom and to use the light measurement signal as an input signal in the generation of the synthesized electronic signal.

19. A musical reed instrument practice kit comprising a reed as claimed in claim 1 and a transducer unit which comprises:
a transducer unit housing adapted to be connected to a musical reed instrument between a mouthpiece and a section of the instrument in which a resonant air chamber is at least partly formed;
an air chamber speaker adapted to deliver sound to the resonant air chamber of the instrument;
an air chamber microphone adapted to receive sound in the resonant air chamber of the instrument;
an electronic processing unit having: an excitation unit which can produce an excitation signal for driving the air chamber speaker; a processor which is connected to the air chamber microphone to receive a measurement signal therefrom and which is adapted to detect from the measurement signal a musical note played by the instrument; a synthesizer for generating a synthesized electronic signal embodying a musical note corresponding to the detected musical note;
an output means adapted to output the synthesized electronic signal; and
a breath tube; wherein:
the transducer unit housing is provided with a breath passage therethrough adapted to connect the mouthpiece chamber with the breath tube; and
the breath tube is adapted to convey breath of a player of the instrument from the breath passage in the housing through the resonant air chamber to be vented to atmosphere outside of the air chamber.

20. An assembly of a transducer unit as claimed in claim 17 and a reed musical instrument, wherein:
the reed musical instrument has a mouthpiece with the mouthpiece chamber and an instrument section which forms at least part of the resonant air chamber and includes a bell via which the air chamber opens to atmosphere;
the transducer unit housing is connected between the mouthpiece and the instrument section which forms at least part of the resonant air chamber; and
the breath tube extends from the transducer unit housing inside the resonant air chamber along an entire length of the resonant air chamber to protrude out of the bell to thereby deliver breath of the player to atmosphere while keeping the breath separate from air in the resonant air chamber.

21. A musical reed instrument practice kit comprising a reed as claimed in claim 3 and a transducer unit which comprises:
a transducer unit housing adapted to be connected to a musical reed instrument between a mouthpiece and a section of the instrument in which a resonant air chamber is at least partly formed;
an air chamber speaker adapted to deliver sound to the resonant air chamber of the instrument;
an air chamber microphone adapted to receive sound in the resonant air chamber of the instrument;
an electronic processing unit having: an excitation unit which can produce an excitation signal for driving the air chamber speaker; a processor which is connected to the air chamber microphone to receive a measurement signal therefrom and which is adapted to detect from the measurement signal a musical note played by the instrument; a synthesizer for generating a synthesized electronic signal embodying a musical note corresponding to the detected musical note;
an output means adapted to output the synthesized electronic signal; and
a breath tube; wherein:
the transducer unit housing is provided with a breath passage therethrough adapted to connect the mouthpiece chamber with the breath tube; and
the breath tube is adapted to convey breath of a player of the instrument from the breath passage in the housing through the resonant air chamber to be vented to atmosphere outside of the air chamber.

22. A reed as claimed in claim 3 wherein each cantilever arm comprises:
an upper arm section:
an elbow;
a lower arm section; and
a hand section for supporting the reflector or the obscuring element: wherein the upper arm section extends from the reed body to the elbow:
the lower arm section extends from the elbow to the hand section:
a first included angle between the upper arm section and the reed body is in the range 35 to 55 degrees; and
a second included angle at the elbow between the upper arm section and the lower are section is in the range 125 to 155 degrees.

23. A reed as claimed in claim 22 wherein:
the upper arm section of each cantilever arm tapers from the reed body to the elbow whereby the upper arm section has a cross-section area, taken perpendicular to a principal axis of the upper arm section, which is greater at a reed body end of the upper arm section than at an elbow end of the upper arm section.

24. A reed as claimed in claim 22 wherein:
the lower arm section of each cantilever arm tapers from the elbow to the hand portion whereby the lower arm section has a cross-section area, taken perpendicular to a principal axis of the lower arm section, which is greater at an elbow end of the lower arm section than at a hand portion end of the lower arm section.

25. A musical reed instrument practice kit comprising a reed as claimed in claim 3 and a transducer unit, the transducer unit comprising:
a transducer unit housing adapted to be connected to a musical reed instrument between a mouthpiece and a section of the instrument in which a resonant air chamber is at least partly formed;
an air chamber speaker adapted to deliver sound to the air chamber of the instrument;
an air chamber microphone adapted to receive sound in the air chamber of the instrument;
an electronic processing unit having: an excitation unit which can produce an excitation signal for driving the air chamber speaker; a processor which is connected to the air chamber microphone to receive a measurement signal therefrom and which is adapted to detect from the measurement signal a musical note played by the instrument; a synthesizer for generating a synthesized electronic signal embodying a musical note corresponding to the detected musical note; and an output means adapted to output the synthesized electronic signal;
a light source adapted to emit light into a mouthpiece chamber of the mouthpiece; and
a light sensor adapted to receive light reflected from the reflector supported by the cantilever arm and to generate a light measurement signal indicative of the intensity of the received light; wherein:
the processor and/or the synthesizer unit is/are connected to the light sensor to receive the light measurement signal therefrom and to use the light measurement signal as an input signal in the generation of the synthesized electronic signal.

26. A musical reed instrument practice kit as claimed in claim 25 wherein the transducer unit comprises additionally a pressure sensor adapted to sense pressure of air in the mouthpiece chamber and to generate a mouthpiece air pressure signal indicative of the sensed mouthpiece air pressure and wherein the processor and/or the synthesizer unit is/are connected to the pressure sensor to receive the mouthpiece air pressure measurement signal therefrom and to use the mouthpiece air pressure signal as an input signal in the generation of the synthesized electronic signal.

27. A musical reed instrument practice kit as claimed in claim 25 wherein the light source emits light in the infrared spectrum.

28. A musical reed instrument practice kit as claimed in claim 25 comprising a breath tube and wherein the transducer unit housing is provided with a breath passage therethrough adapted to connect the mouthpiece chamber with the breath tube, the breath tube being adapted to convey breath of a player of the instrument from the breath passage in the housing through the air chamber to be vented to atmosphere outside of the air chamber.

29. A reed musical instrument having a mouthpiece and, secured to the mouthpiece by a ligature, a reed as claimed in claim 3, wherein:
each cantilever arm extends through an aperture in the mouthpiece;
the reflector is located within a mouthpiece cavity in the mouthpiece, facing away from a tip end from the mouthpiece cavity; and
each cantilever arm is connected to the mouthpiece only via the reed body.

30. An assembly of a reed musical instrument and musical reed instrument practice kit as claimed in claim 25 wherein:
the transducer unit housing of the musical reed instrument practice kit is secured between the mouthpiece and the section of the musical instrument in which the air chamber is at least partly formed, with the air chamber speaker and the air chamber microphone facing into the air chamber and with the light source and the light sensor facing into the mouthpiece chamber of the mouthpiece;
the reed of the musical reed instrument practice kit secured to the mouthpiece by a ligature with each cantilever arm of the reed extending through an aperture in the mouthpiece into the mouthpiece chamber;
the reflector is located within the mouthpiece chamber facing away from a tip end from the mouthpiece chamber and facing toward the light source and the light sensor; and
each cantilever arm is connected to the mouthpiece only via the reed body.

31. A method of use of the reed of claim 3 comprising:
replacing a standard reed of a reed musical instrument reed with the reed claimed in claim 3, securing said reed to a mouthpiece of the reed musical instrument with a ligature of the reed musical instrument;
inserting each cantilever arm of said reed into a mouthpiece chamber through an aperture in the mouthpiece; and
locating the reflector within the mouthpiece chamber with the reflector facing away from a tip end from the mouthpiece chamber.

32. A method of use of the musical reed instrument practice kit of claim 25 comprising:
replacing a standard reed of a reed musical instrument reed with the reed claimed in claim 25, securing said reed to a mouthpiece of the reed musical instrument with a ligature of the reed musical instrument;
inserting each cantilever arm of said reed through an aperture in the mouthpiece;
locating the reflector within a mouthpiece chamber in the mouthpiece, with the reflector facing away from a tip end from the mouthpiece chamber; and
securing the housing of the transducer unit between the mouthpiece and a section of the reed musical instrument in which a resonant air chamber is at least partly formed, with the air chamber speaker and the air chamber microphone operative in the air chamber and with the light source and the light sensor operative in the mouthpiece chamber.
